(19) United States
(12) Patent Application Publication
(10) Pub. No.: US 2024/0063744 A1
(43) Pub. Date: Feb. 22, 2024

(54) ROTOR FLUX TIME DELAY REDUCTION THROUGH INITIAL ROTOR CURRENT FOR ELECTRICALLY EXCITED SYNCHRONOUS MACHINES

(71) Applicant: Tula eTechnology, Inc., San Jose, CA (US)

(72) Inventors: Zakirul ISLAM, San Jose, CA (US); Paul CARVELL, Aptos, CA (US); Philippe FARAH, Maisons-Laffitte (FR)

(21) Appl. No.: 18/452,050

(22) Filed: Aug. 18, 2023

Related U.S. Application Data
(60) Provisional application No. 63/399,622, filed on Aug. 19, 2022.

(51) Int. Cl. H02P 27/08

(52) U.S. Cl. CPC H02P 27/085

(57) ABSTRACT

An electric machine comprising a power supply and an electrically excited synchronous machine is provided. The electrically excited synchronous machine comprises a stator with stator windings and a rotor with a plurality of rotor poles, wherein the rotor has a magnetic field knee region and rotor field windings around the plurality of rotor poles. A power converter is coupled between the power supply and the electrically excited synchronous machine. The power converter is arranged to provide a pulsed operation by providing a pulsed current to the stator windings and a pulsed DC current to the rotor field windings, wherein the pulsed DC current continuously provides a magnetic field in the rotor.

### CROSS-REFERENCE TO RELATED APPLICATION

This application claims the benefit of priority of U.S. Application No. 63/399,622, filed Aug. 19, 2022, which is incorporated herein by reference for all purposes.

### BACKGROUND

The present application relates generally to pulsed control of electric machines to selectively deliver a desired output in a more energy efficient manner, and more particularly, to pulsed electric electrically excited synchronous machines, such as electrically excited synchronous machines.

The term “machine” as used herein is intended to be broadly construed to mean both electric motors and generators. Electric motors and generators are structurally very similar. Both include a stator having a number of poles and a rotor. When a machine is operating as a motor, it converts electrical energy into mechanical energy. When operating as a generator, the machine converts mechanical energy into electrical energy.

### SUMMARY

A variety of methods, controllers, and electric machine systems are described that facilitate pulsed control of a multiple electric machine (e.g., electric motors and generators) drive system to improve the energy conversion efficiency of the electric machines when operating conditions warrant. More specifically, an electric machine comprising a power supply and an electrically excited synchronous machine is provided. The electrically excited synchronous machine comprises a stator with stator windings and a rotor with a plurality of rotor poles, wherein the rotor has a magnetic field knee region and rotor field windings around the plurality of rotor poles. A power converter is coupled between the power supply and the electrically excited synchronous machine. The power converter is arranged to provide a pulsed operation by providing a pulsed current to the stator windings and a pulsed DC current to the rotor field windings, wherein the pulsed DC current continuously provides a magnetic field in the rotor.

In another embodiment, a method of operating an electrically excited synchronous machine comprising a rotor with rotor poles and rotor field windings and a stator with stator windings is provided. A pulsed operation is provided comprising providing a pulsed current to the stator windings and providing a pulsed DC current to the rotor field windings, wherein the pulsed DC current to the rotor field windings creates a magnetic field in the rotor and wherein the rotor has a magnetic field knee region and wherein the magnetic field created by the pulsed DC current is continuously provided in the rotor.

In another embodiment, an electric machine comprising a power supply and an electrically excited synchronous machine is provided. The electrically excited synchronous machine comprises a stator with stator windings, a rotor with a plurality of rotor poles, wherein the rotor has a magnetic field knee region, and rotor field windings around the plurality of rotor poles. A power converter is coupled between the power supply and the electrically excited synchronous machine. The power converter is arranged to provide a pulsed operation by providing a pulsed current to the stator windings, wherein the pulsed operation provides periodic switch off times (T_{O}) and switch on times (T_{S}) for current in the stators and a pulsed DC current to the rotor field windings, wherein at the switch on times (T_{O}) the magnetic field in the rotor is at or above the magnetic field knee region of the rotor.

In another embodiment, a method of operating an electrically excited synchronous machine comprising a rotor with rotor poles and rotor field windings and a stator with stator windings is provided. A pulsed operation comprises providing a pulsed current to the stator windings, wherein the pulsed current to the stator windings provides periodic switch off times (T_{O}) and switch on times (T_{S}) for current in the stators, and providing a pulsed DC current to the rotor field windings, wherein the pulsed DC current to the rotor field windings creates a magnetic field in the rotor and wherein the rotor has a magnetic field knee region, wherein at the switch on times (T_{O}) the magnetic field in the rotor is at or above the magnetic field knee region of the rotor.

These and other features of the present disclosure will be described in more detail below in the detailed description of the disclosure and in conjunction with the following figures.

### BRIEF DESCRIPTION OF THE DRAWINGS

The invention and the advantages thereof may best be understood by reference to the following description taken in conjunction with the accompanying drawings in which:

FIG. 1 is a representative Torque/Speed/Efficiency graph illustrating the energy conversion efficiency of a representative electric machine under different operating conditions.

FIG. 2 is a graph illustrating a pulsed torque signal applied to an electric machine.

FIG. 3A is a torque versus efficiency map for an electric machine operating at a fixed speed during a transition from zero to peak efficiency torque.

FIG. 3B is a torque versus work lost for an exemplary motor operating at a fixed speed during a transition from zero to peak efficiency torque.

FIG. 4 illustrates a pulsed controlled electric machine in accordance with a non-exclusive embodiment.

FIG. 5A is a diagrammatic representation of a continuous three-phase AC waveform having a peak value of 50 Amperes for stator windings.

FIG. 5B is a diagrammatic representation of a continuous DC signal at 5 Amperes for rotor field windings.

FIGS. 5C and 5E are pulsed waveforms having a 50% duty cycle that provide the same power output as the continuous waveform of FIG. 5A.

FIGS. 5D and 5F are pulsed DC signals having a 50% duty cycle that provide the same power output as the continuous DC signal of FIG. 5B.

FIGS. 6A-6C are signal diagrams illustrating the benefits of a non-exclusive embodiment.

FIG. 7 is a graph illustrating an example relationship between voltage rise time and current rise time for rotor field windings of an EESM.

FIG. 8 is a graph of an example rotor flux and inductance versus current for rotor field windings of an EESM.

FIG. 9A is a graph of flux density versus magnetic field for an example rotor.

FIG. 9B provides graphs of flux density versus magnetic field for iron and air.

FIG. 10A illustrates a pulsed DC rotor field current that is used in some embodiments for a 140 turn rotor.

FIG. 10B illustrates a pulsed DC rotor field current that is used in some embodiments for an 80 turn rotor.

FIG. 11 is a flow diagram illustrating steps for pulsed control operation of an electric machine in a vehicle in accordance with a non-exclusive embodiment.

FIG. 12 is a schematic illustration of part of a cross-section of an electrically excited synchronous machine.

FIG. 13 illustrates a pulsed DC rotor field current that is used in some embodiments.

FIG. 14 illustrates a pulsed DC rotor field current that is used in some embodiments.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

Modern electric machines have relatively high energy conversion efficiencies. The energy conversion efficiency of most electric machines, however, can vary considerably based on their operational load. With many applications, a machine is required to operate under a wide variety of different operating load conditions. As a result, machines typically operate at or near the highest levels of efficiency at certain times, while at other times, they operate at lower efficiency levels.

Battery powered electric vehicles provide a good example of an electric machine operating at a wide range of efficiency levels. During a typical drive cycle, an electrical vehicle will accelerate, cruise, de-accelerate, brake, corner, etc. Within certain rotor speed and/or torque ranges, the electric machine operates at or near its most efficient operating point, i.e., its “sweet spot”. Outside these ranges, the operation of electric machines is less efficient. As driving conditions change, the machine transitions between high and low operating efficiency levels as the rotor speed and/or torque changes. If the electric machine could be made to operate a greater proportion of a drive cycle in high efficiency operating regions, the range of the vehicle for a given battery charge level would be increased. Since the limited range of battery powered electric vehicles is a major commercial impediment to their use, extending the operating range of the vehicle is highly advantageous. A need, therefore, exists to operate electric machines, such as motors and generators, at higher levels of efficiency.

The present application relates generally to pulsed control of electric electrically excited synchronous machines (also known as wound field synchronous machines) that would otherwise be operated in a continuous manner. By pulsed control, the machine is intelligently and intermittently pulsed on and off to both (1) meet operational demands while (2) improving overall efficiency. More specifically, under selected operating conditions, an electric machine is intermittently pulse-driven at more efficient energy conversion operating levels to deliver the desired average output more efficiently than would be attained by conventional continuous machine operation. Pulsed operation results in deliberate modulation of the electric machine torque; however, the modulation is managed in such a manner such that levels of noise or vibration are minimized for the intended application.

For the sake of brevity, the pulsed control of electric electrically excited synchronous machines as provided herein is described in the context of a three-phase electric electrically excited synchronous electric machine in a vehicle. This explanation, however, should not be construed as limiting in any regard. On the contrary, the pulse control as described herein can be used for many types of electric electrically excited synchronous electric machines, meaning both electric motors and generators. In addition, pulsed control of such electric electrically excited synchronous machines may be used in any application, not just limited to electric vehicles. In particular, pulsed control may be used in systems that require lower acceleration and deceleration rates than vehicle applications, such as electric electrical machines for heating, cooling, and ventilating systems.

Pulsed engine control is described in U.S. patent application Ser. No. 16/353,159 filed on Mar. 14, 2019, and U.S. Provisional Patent Application No. 62/644,912, filed on Mar. 19, 2018; 62/658,739, filed on Apr. 17, 2018; and 62/810,861 filed on Feb. 26, 2019. Each of the foregoing applications is incorporated herein by reference in their entirety.

### Electrically Excited Synchronous Machines

Electrically excited synchronous machines are motors or generators that are able to convert electricity to mechanical movement or mechanical movement to electricity without permanent magnets. Electrically excited synchronous machines may be electrically excited synchronous machines (EESM) and electrically excited synchronous generators.

Electrically excited synchronous machines, also referred to as Wound Field Synchronous Machines or Externally Excited Synchronous Machines include:
electrically excited synchronous rotors, where the rotor field coil (also called field windings) is located in the rotor and therefore called rotor winding, whereas the stator phase windings are in the stator and therefore called stator windings;
or flux switching where both the field coil and the stator windings are located in the stator. In an electrically excited synchronous machine, the field coil is powered by a DC power source. In most electrically excited synchronous machines, the stator windings are powered by an AC power source. In most electrically excited synchronous machines, the rotor field coil is on the rotor and the stator windings are on the stator. In such electrically excited synchronous machines, slip rings may be used to provide electrical contacts between the DC power source and the rotor field coils on the rotor. In other embodiments, an airgap may be used to provide electrical contact. A DC motor would place the field coils on the stator and use a commutator connected to the rotor in order to convert DC power to AC power.

### Three-Phase Electrically Excited Synchronous Machine

In a three-phase electrically excited synchronous machine, the stator may include a three-coil winding that is excited by a three-phase AC input and the rotor windings are on the rotor that are powered by a DC input. When the three-phase AC input is passed through the three-phase armature windings, a rotating magnetic field (RMF) is generated. The rotational rate of the RMF is known as the synchronous speed (Nₛ) of the electric machine. The interaction of the rotor winding fields and stator winding fields generates an electromagnetic force (EMF) causing the rotor rotation.

### Vehicle Motor Efficiency Map

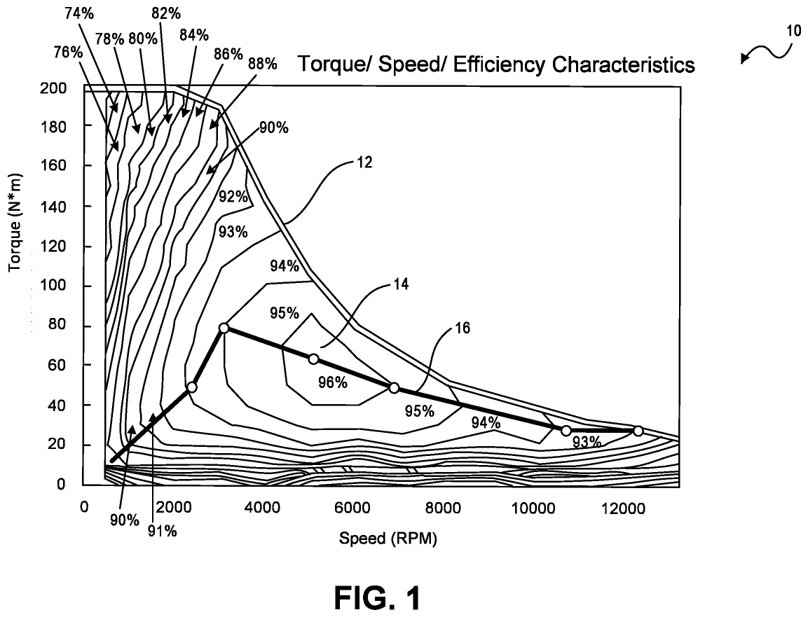

Referring to FIG. 1, an exemplary vehicle motor efficiency map 10 under different load and speed conditions is illustrated. The map 10 plots torque (N*m) along the vertical axis as a function of motor speed (RPM) along the horizontal axis. The maximum steady-state output power is given by curve 12. The exemplary vehicle motor efficiency map is shown to help illustrate an increase in efficiency of an electrically excited synchronous motor (EESM) that may be provided by an embodiment.

The area under the peak-torque/speed curve 12 is mapped into a plurality of regions, each labeled by an operational efficiency percentage. For the particular motor shown, the following characteristics are evident:
The most efficient or “sweet-spot” region of its operating range is the operating region labeled 14, which is generally in the range of 4,500-6,000 RPM with a torque output in the range of about 40-70 N*m. In Region 14, the energy conversion efficiency is on the order of 96%, making it the “sweet spot”, where the electric machine is operating in its most efficient operating range.
As the electric machine speed increases beyond approximately 6,000+ RPM, the efficiency tends to decrease, regardless of the output torque.
As the output torque increases beyond 70 N*m or falls below 40 N*m, the efficiency percentage tends to decrease from its peak, in some situations rather significantly. For example, when the electric machine is operating at approximately 2,000 RPM and an output torque of 100 N*m, the efficiency is approximately 86%. When torque output falls below about 30 N*m, regardless of the electric machine speed, the efficiency drops, approaching zero at zero load.
At any particular motor speed, there will be a corresponding most efficient output torque, which is diagrammatically illustrated by a maximum efficiency curve 16.

The map 10 as illustrated was derived from an electric machine used in a 2010 Toyota Prius. Map 10 is for an internal permanent magnet synchronous electric machine. It should be understood that this map 10 is merely illustrative and should not be construed as limiting in any regard. A similar map can be generated for just about any electric machine, for example, a 3-phase induction machine, regardless of whether used in a vehicle or in some other application.

As can be seen from the map 10, the electric machine is generally most efficient when operating within the speed and torque ranges of the sweet spot 14. If the operating conditions can be controlled so that the electric machine operates a greater proportion of time at or near its sweet spot 14, the overall energy conversion efficiency of the electric machine can be significantly improved.

From a practical point of view, however, many driving situations dictate that the motor operates outside of the speed and torque ranges of the sweet spot 14. In electric vehicles it is common to have no transmission and as such have a fixed ratio of the electric machine rotation rate to the wheel rotation rate. In this case, the motor speed may vary between zero, when the vehicle is stopped, to a relatively high RPM when cruising at highway speeds. The torque requirements may also vary widely based on factors such as whether the vehicle is accelerating or decelerating, going uphill, going downhill, traveling on a level surface, braking, etc.

As can be seen in FIG. 1, at any particular motor speed, there will be a corresponding most efficient output torque which is diagrammatically illustrated by maximum efficiency curve 16. From a conceptual standpoint, when the desired motor torque is below the most efficient output torque for the current motor speed, the overall efficiency of the motor can be improved by pulsing the electric machine, so as to operate the electric machine a proportion of time at or near its sweet spot and the remainder of the time at a low or zero torque output level. The average torque thus generated is controlled by controlling the duty cycle of sweet spot operation.

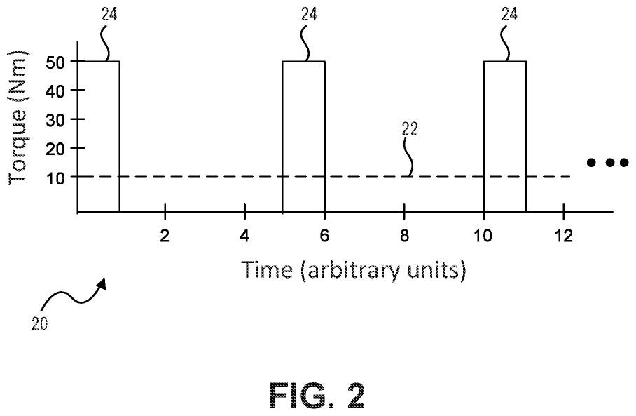

Referring to FIG. 2, a graph 20 plotting torque on the vertical axis versus time on the horizontal axis is illustrated. During conventional operation, the electric machine would continuously generate 10 N*m, indicated by dashed line 22, so long as the desired torque remained at this value. With pulsed-control operation, the electric machine is pulsed with a current pulse signal, as represented by pulses 24, to deliver 50 N*m of torque for 20% of the time. The remaining 80% of the time, the electric machine is off. The net output of the motor, therefore, meets the operational demand of an average torque level of 10 N*m. Since the electric machine operates more efficiently when it is delivering 50 N*m than when it delivers a continuous torque of 10 N*m, the electric machine's overall efficiency can thus be improved by pulsing the electric machine using a 20% duty cycle while still meeting the average torque demand. Thus, the pulsed operation provides a higher energy efficiency than the continuous operation.

In the above example, the duty cycle is not necessarily limited to 20%. As long as the desired electric machine output does not exceed 50 N*m, the desired motor output can be met by changing the duty cycle. For instance, if the desired motor output changes to 20 N*m, the duty cycle of the electric machine operating at 50 N*m can be increased to 40%; if the desired motor output changes to 40 N*m, the duty cycle can be increased to 80%; if the desired electric machine output changes to 5 N*m, the duty cycle can be reduced to 10% and so on. Generally, pulsed motor control can potentially be used advantageously any time that the desired electric machine torque falls below the maximum efficiency curve 16 of FIG. 1.

On the other hand, when the desired electric machine torque is at or above the maximum efficiency curve 16, the motor may be operated in a conventional (continuous or non-pulsed) manner to deliver the desired torque. Pulsed operation offers an opportunity for efficiency gains when the electric machine is required to deliver an average torque below the torque corresponding to its maximum operating efficiency point.

It should be noted that torque values and time scale provided in FIG. 2 are merely illustrative and are not intended to be limiting in any manner. In actual electric machine pulsing embodiments, the pulse duration used may widely vary based on the design needs of any particular system. In general, however, the scale of the periods for each on/off cycle is expected to be on the order of 10 milliseconds (ms) to 0.10 seconds (i.e., pulsing at a frequency in the range of 10 to 100 Hz). Furthermore, there are a wide variety of different electrically excited synchronous electric machines, and each electrically excited synchronous motor has its own unique efficiency characteristics. Further, at different electric machine speeds, a given motor will have a different efficiency curve. The nature of the curve may vary depending on the particular electrically excited synchronous electric machine or a particular application. For example, torque output need not be flat topped as depicted in FIG. 2, and/or the torque need not go to zero during the off periods but may be some non-zero value. Regardless of the particular curve used, however, at some proportion of the time the electrically excited synchronous motor is operating is preferably at or near its highest efficiency region for a given electrically excited synchronous electric machine speed.

Efficiency Improvements with Improved Faster Current Rise and Fall

The vast majority of current motor converters are typically designed for continuous, not pulsed operation. Such electrical machines generally transition from the unenergized to an energized state relatively infrequently. As a result, little design effort is made in managing such transitions. To the extent any design effort is made in managing the transition, it is typically directed to achieving a smooth transition as opposed to a fast transition. The transition from the energized to energized states for most electrical machines is therefore often rate limited (i.e., relatively not fast).

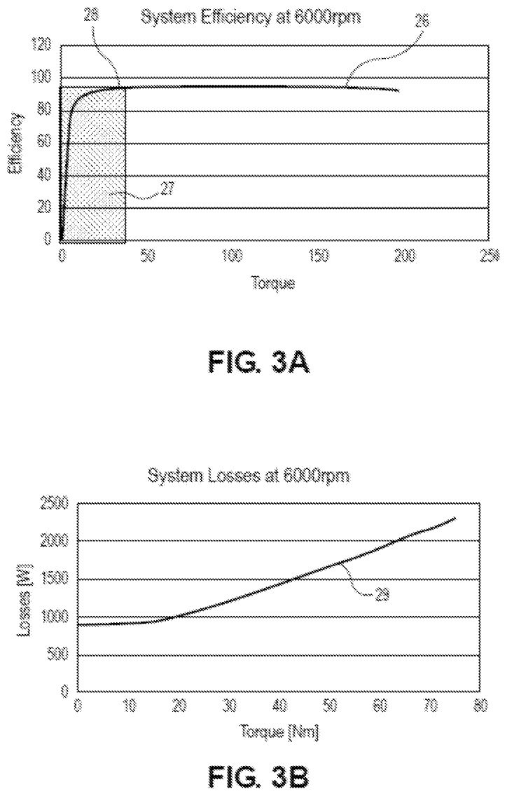

It has been discovered that for an electric motor system that regularly transitions from an unenergized electric machine state to a peak efficiency state such as with pulsed operation, even further efficiency improvements can be realized when the transitions occur as fast as possible. With fast transitions, for example, from zero torque to the peak efficiency torque, the overall average motor efficiency is improved because the electric machine spends less time in transition where efficiency is less than the peak. This relationship is depicted in FIG. 3A and FIG. 3B.

Referring to FIG. 3A, a torque versus efficiency map for an exemplary electric motor operating at a fixed speed (e.g., 6000 rpms) is illustrated. In the exemplary map, a range of torque outputs from 0.0 Nm to 250 Nm is plotted along the horizontal axis, while the efficiency of the motor from 0.0 percent to 100 percent is plotted along the vertical axis. The curve 26 depicts the transition of the electric machine from zero to peak efficiency torque. During this transition, as depicted by the shaded region 27, the electric motor has a much lower efficiency than the peak efficiency torque 28.

Referring to FIG. 3B, a map is provided illustrating torque versus work lost for an exemplary electric machine operating at a fixed speed during a transition from zero to peak efficiency torque. In this map, the work losses (W) are plotted along the vertical axis, while the torque output of the motor is plotted along the horizontal axis. As demonstrated by the curve 29, the work losses of the motor increase as the torque output increases during the transition from zero to peak efficiency torque. Therefore, the faster the transition time from zero to peak efficiency torque, the less work is performed, and the less energy is consumed by the electric machine.

By substituting time in place of torque along the horizontal axis and then integrating the area under the curve 29, the energy consumed by the electric machine can be calculated for a given transition time. For instance, with an exemplary motor, 7234.5 Joules of energy was used with a transition time of 0.5 seconds, while only 723.4 Joules of energy were used with a transition time of 0.05 seconds. This comparison demonstrates that the faster the transition time from zero to peak efficiency torque, the lower the energy consumed in losses. It should be noted that with this example, it is assumed that no acceleration of the load has taken place, so no energy has been added to the load inertia. Just as efficiency is increased by decreasing rise time, efficiency is increased by decreasing fall time.

For different electrical machines, the transition of the electric machine from zero to peak efficiency torque, the peak efficiency torque and the work losses will all vary. The maps of FIG. 3A and FIG. 3B should therefore be viewed as merely exemplary and should not be construed as limiting in any regard.

### Power Converter

Power inverters are known devices that are used with electric machines for converting a DC power supply, such as that produced by a battery or capacitor, into three-phase AC input power applied to electric machine stator windings. In response, the stator windings generate the RMF as described above.

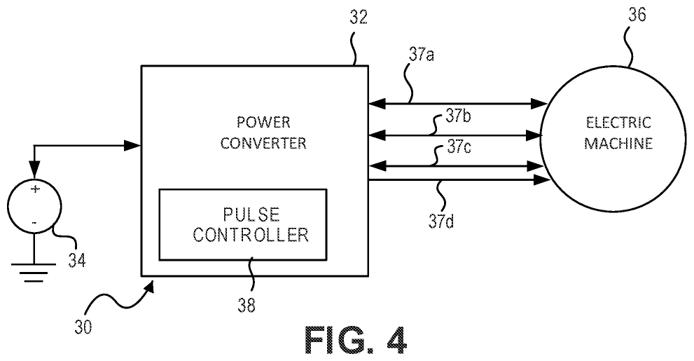

Referring to FIG. 4, a diagram of a power controller 30 for pulsed operation of an electric machine is illustrated. The power controller 30 includes a power converter 32, a DC power supply 34, and an electric machine 36. In this non-exclusive embodiment, the power converter 32 comprises a pulse controller 38. The power converter 32 may be operated as a power inverter or power rectifier depending on the direction of energy flow through the system. When the electric machine is operated as a motor, the power converter 32 is responsible for generating three-phased AC power from the DC power supply 34 to drive the electric machine 36. The three-phased input power, denoted as phase A 37a, phase B 37b, and phase C 37c, is applied to the windings of the stator of the electric machine 36 for generating the RMF as described above. The lines depicting the various phases, 37a, 37b, and 37c are depicted with arrows on both ends indicating that current can flow both from the power converter 32 to the electric machine 36 when the electric machine is used as a motor and that current can flow from the electric machine 36 to the power converter 32 when the machine is used as a generator. When the electric machine is operating as a generator, the power converter 32 operates as a power rectifier, and the AC power coming from the electric machine 36 is converted to DC power being stored in the DC power supply. The line depicting the field current, 37d carries a DC field current that typically is unidirectional for both the motor and generator operating modes.

The pulse controller 38 is responsible for selectively pulsing the three-phased input power. During conventional (i.e., continuous) operation, the three-phased and rotor field coil input power is continuous or not pulsed. On the other hand, during pulsed operation, the three-phased and rotor field coil input power is pulsed. Pulsed operation may be implemented, in non-exclusive embodiments, using any of the approaches described herein, such as but not limited to the approaches described below.

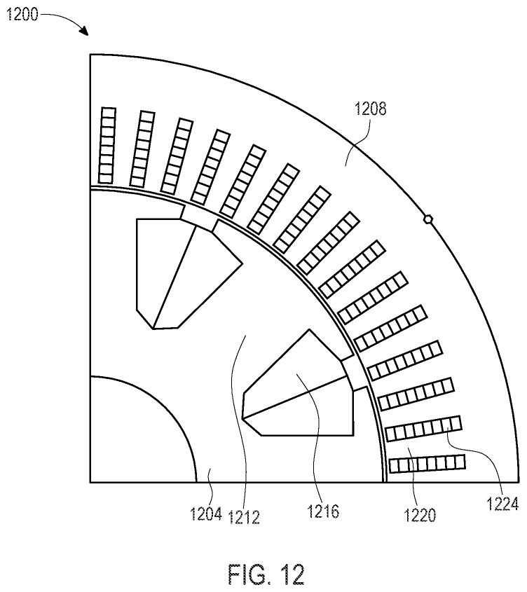

FIG. 12 is a schematic illustration of part of a cross-section of an electrically excited synchronous machine 1200. The EESM 1200 comprises a rotor 1204 and a stator 1208. The rotor 1204 comprises a plurality of rotor poles 1212 and rotor field windings 1216 wrapped around the rotor poles 1212. The stator 1208 comprises a plurality of stator poles and stator windings 1224 wrapped around the stator teeth 1220 defined by coil slots. One or more stator teeth 1220 are connected to a stator pole of the stator 1208.

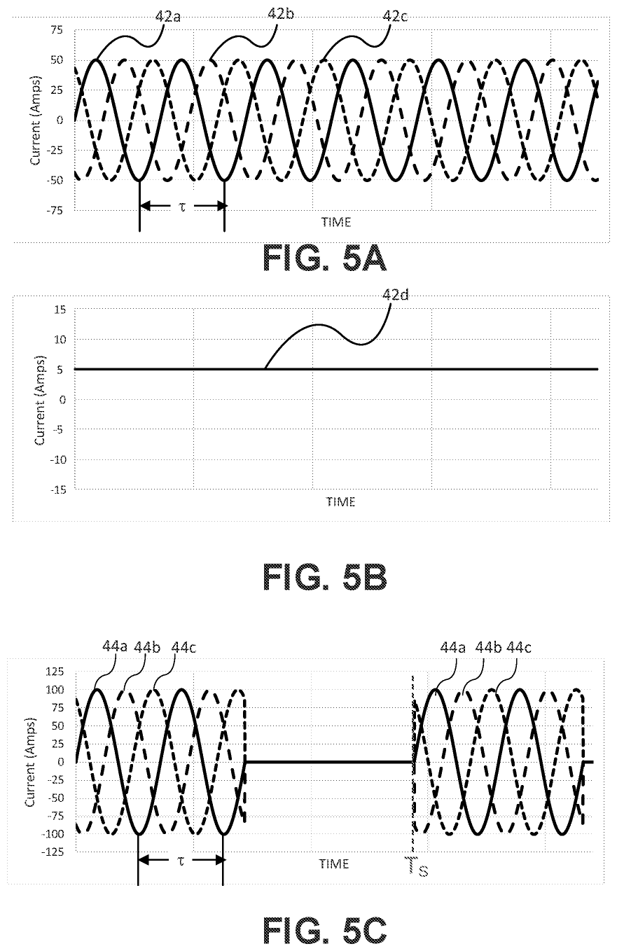

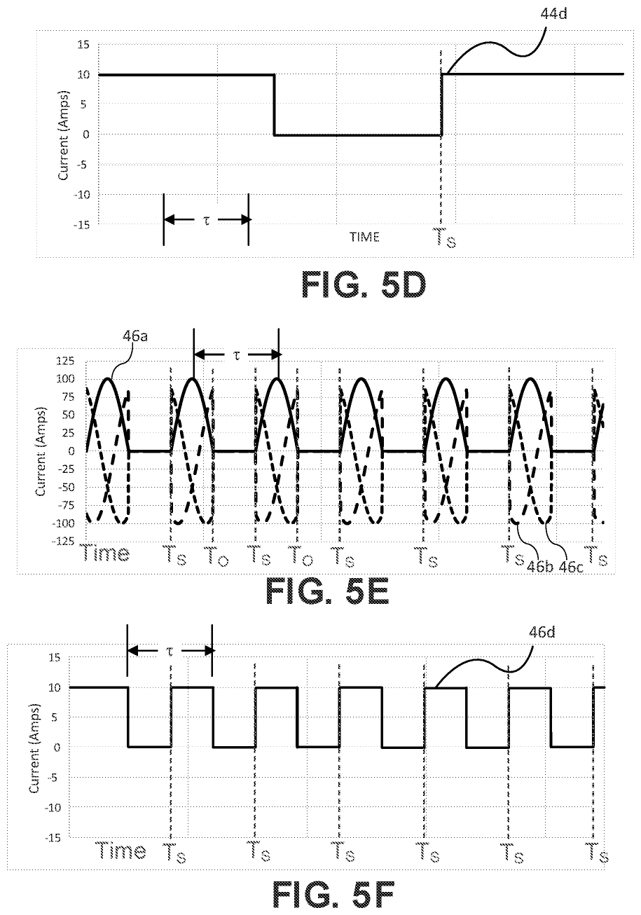

Referring to FIG. 5A-5F, plots are provided for illustrating the difference between continuous and pulsed three-phased and field current input power provided to the electric machine 36. In each plot, phase and rotor field currents are plotted on the vertical axis, and time is plotted along the horizontal axis.

FIG. 5A illustrates conventional sinusoidal three-phased input current 42a, 42b, and 42c delivered to the stator windings of the electric machine 36. Phase B, denoted by curve 42b lags phase A, denoted by 42a by 120 degrees. Phase C, denoted by curve 42c, lags phase B by 120 degrees. The sine wave period is t. The three-phased input current 42a, 42b, and 42c is continuous (not pulsed) and has a designated maximum amplitude of approximately 50 amps. FIG. 5B illustrates the conventional DC rotor field current 42d delivered to the rotor field coils. The rotor field current is continuous (not pulsed) and has an amplitude of 5 amps. It should be appreciated that 50 amps (for the phased current delivered to the stator windings) and 5 amps (for the rotor field current delivered to the rotor field coils) are only a representative maximum current, and the maximum current may have any value.

FIG. 5C and FIG. 5D illustrate an example pulsed three-phased current waveforms 44a, 44b, and 44c, shown in FIG. 5C, with a pulsed DC rotor field current 44d, shown in FIG. 5D that has a 50% duty cycle and peak amplitude of approximately 100 amps for the three-phased waveforms 44a, 44b, and 44c and approximately 10 amps for the DC field current 44d. As in FIG. 5A the period of the base sine wave is τ, however, now the sine wave is modulated on and off. The delivered currents in FIG. 5C and FIG. 5D deliver the same average torque as the continuously applied three-phased input current of FIG. 5A and FIG. 5B (assuming torque is proportional to currents, which is often the case). In FIG. 5C and FIG. 5D, the current pulses 44a-d are interleaved with “off” periods of equal length. The length of each on and off period is 2τ. In this example, the duty cycle is 50%. The frequency of the pulsed modulation may vary based on the type of electrical machine used, noise and vibration considerations, current operating rotor speed, and other factors. The time when the stators are switched on (T_{S}) when current is provided to the stators is shown in FIG. 5C and FIG. 5D.

This example in FIG. 5C and FIG. 5D illustrates an application in which the “on” electric machine drive pulses are evenly spaced while the electric machine is operated at a steady state desired output level. Such an approach works well in many circumstances but is not a requirement. The duty cycle need not be 50% but can be adjusted to match the desired average output torque. In FIG. 5C and FIG. 5D the phase of the on/off pulses is synchronized with the applied power; however, the phase of the on/off pulses need not be synchronized with the phase of the applied power in some embodiments. Thus, the relative sizes and/or timing of the electric machine drive pulses can be varied as long as they average out to deliver the desired average torque.

This example shows how both the stator winding AC current and the DC rotor field coil current may be pulsed. The pulsing is designed to allow the electrically excited synchronous machine to operate at an efficient torque level while reducing the amount of power needed to provide a desired torque level.

FIG. 5E and FIG. 5F illustrate another example of pulsed three-phased current waveforms 46a, 46b, and 46c, shown in FIG. 5E, with a pulsed DC rotor field current 46d, shown in FIG. 5F that has a 50% duty cycle and peak amplitude of approximately 100 amps for the three-phased waveforms 46a, 46b, and 46c and approximately 10 amps for the DC field current 46d. As in FIG. 5A the period of the base sine wave is τ, however, now the sine wave is modulated on and off. The delivered current in FIG. 5E and FIG. 5F delivers the same average torque as the continuously applied three-phased input current of FIG. 5A and FIG. 5B (assuming torque is proportional to currents, which is often the case). In FIG. 5E and FIG. 5F, the current pulses 46a-d are interleaved with “off” periods of equal length. The length of each on and off period is τ/2. In this example, the duty cycle is 50%. The times when the stators are switched on (T_{S} or periodic switch on times) when current is provided to the stators is shown in FIG. 5E and FIG. 5F. FIG. 5E also shows times when the pulsed power to the stators are switched off (T_{O}) or periodic switch of times. The frequency of the pulsed modulation may vary based on the type of electrical machine used, noise and vibration considerations, current operating rotor speed, and other factors.

### Power Converter Circuit

The inherent inductance of the motor can transitorily delay/slow the current/power steps between the on and off motor states. During continuous (non-pulsed) operation, these transitory effects tend to have a relatively minimal impact on overall motor operation. However, when rapid pulsing is used as contemplated herein, the transitory effects can have a larger net impact, and therefore, there is an incentive to reduce the leading and falling edge pulse transition times. This is particularly important for the rotor field current that exhibits a significantly higher time constant than the stator phase currents.

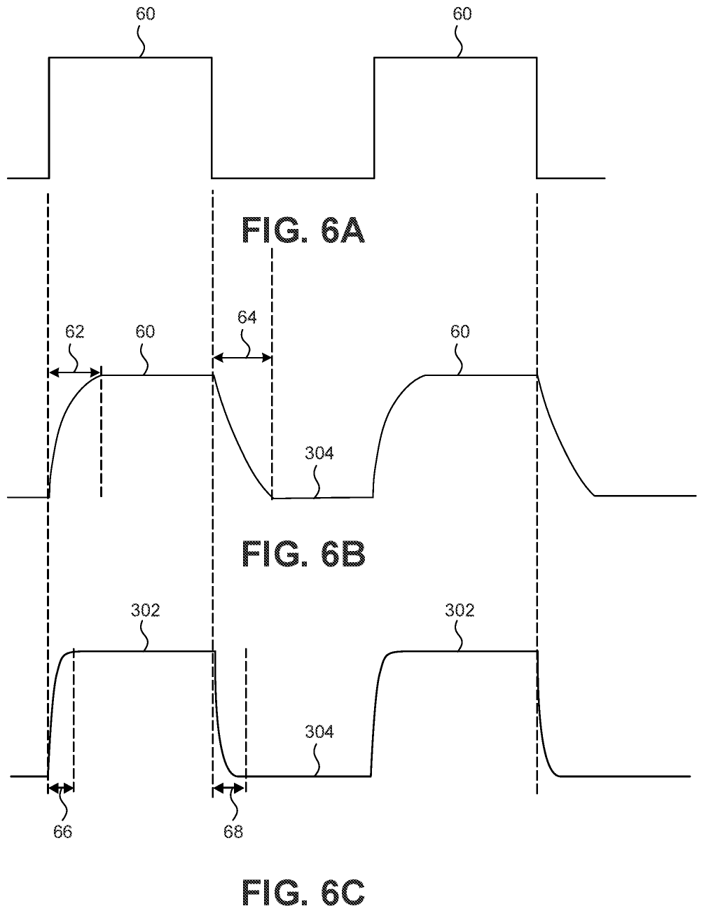

As previously noted, the goal of pulsed electric machine control is to operate the electric machine 36 at substantially its most efficient level for the current machine speed during “on” periods and to cut-off power (provide zero or negligible power) during the “off” periods. For example, the power supplied during the off periods may be less than 10%, 5%, 1%, 0.5%, or 0.1% of the power supplied during the “on” period. The operating point while operating during the “on” period may have an efficiency within 5%, 2%, or 1% of a maximum operating efficiency point of the motor at the current motor speed. The transitions through the low efficiency operating region between the “off” and “on” periods should be as fast as possible to maximize efficiency. Thus, the power transitions between the machine power “on” and “off” states ideally have a leading edge that transitions vertically straight up and a following edge that vertically transitions straight down. Such “perfect” pulses 60 are diagrammatically illustrated in FIG. 6A, which illustrates the ideal motor drive current versus time for pulsed control having a duty cycle of 50%. In this figure, the current pulse represents the rotor field winding current. While the current pulse is shown as flat topped, this will not necessarily be the case.

In the real-world, a number of practical limitations make generation of such perfect pulses difficult to achieve. For instance, inductive aspects of both the electric machine 36 and the power converter 32 circuitry slow down the current rise and fall times. The actual response of a particular machine will vary with the electrical characteristics of the electric machine 36, the rotational speed of the electric machine, and the available bus voltages. In general, the actual rise and fall of pulses occur more gradually, meaning the transitions occur over time. The nature of the rise and fall in the real world is diagrammatically illustrated in FIG. 6B. As seen therein, there is a ramp-up period (rise time) 62 required for the current to actually rise from zero to the desired “on” power level and a ramp-down period (fall time) 64 required for the current to actually fall from the “on” power level down to zero.

During the power ramp-up and ramp-down periods, the electrically excited synchronous electric machine 36 continues to consume or generate power. However, the electrically excited synchronous machine operates less efficiently during these transition periods. In general, the electrically excited synchronous machine efficiency will drop as the operating current drops from its maximum efficiency condition (curve 16 FIG. 1) towards zero, with the energy conversion efficiency getting noticeably worse as the current level approaches zero. Thus, the pulse distortion represented by the current ramp-up and ramp-down periods detracts from efficiency gains resulting from pulsed operation. In general, the smaller the ratio of the rise/fall times to the pulse length, the less the transitory switching effects impact the machine's energy conversion efficiency during pulsing.

It should be appreciated that the transitory effects shown in FIG. 6B are illustrative in nature and do not necessarily reflect actual rise/fall times associated with the operation of any particular electrically excited synchronous machine. The relative scale of the rise time to the pulse length ratio can vary widely based on the characteristics of the electrically excited synchronous machine used (which primarily dictates the rise and fall times), the frequency of the pulsing (which is primarily dictated by the control scheme used) and the pulse width (which is dictated by the control scheme and machine load). The voltage available to power the electrically excited synchronous electric machine and machine rotation speed will also impact the pulse rise and fall times. If the pulsing is slow compared to the electrically excited synchronous machine response, the rise/fall times may be a small fraction of the pulse width, and the transitory switching effects may have a minimal impact on machine performance. Conversely, if the pulsing is very rapid and/or the electrically excited synchronous machine response is low, the rise/fall times may be a significant fraction of the pulse width and can even exceed the pulse width in some situations. If not managed carefully, the transitory efficiency losses associated with switching can significantly reduce or even eliminate any theoretical gains that can be attained by pulsed operation. Thus, it is important to consider the transitory switching effects associated with the pulsed operation when determining the pulsing frequency and control schemes that are appropriate for any particular application.

Various embodiments provide a pulsed control electrically excited synchronous machine with rise times and fall times of less than 5 ms. However, using a conventional power system with a conventional electrically excited synchronous motor, a build or decay of no more than 5 ms is not obtained. In various embodiments, the pulsed control provides pulses with a frequency of at least 10 Hz and a period no more than 100 ms and where the rise time is less than 10% of the period.

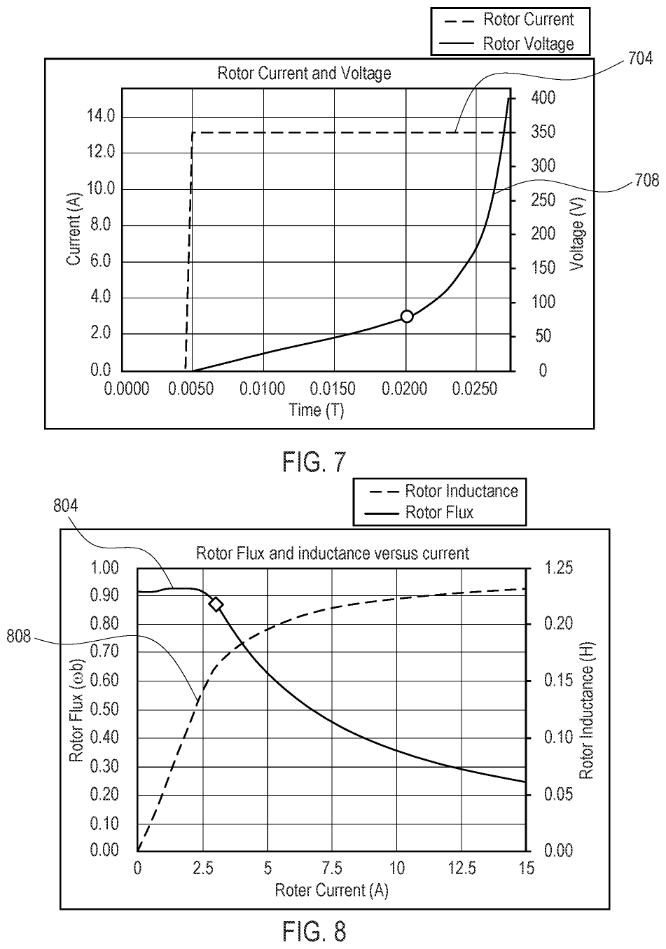

For rotor field windings current rise times and fall times are related to a time constant that is a function of L/R, where L is the inductance of the rotor field windings and R is the resistance in the rotor field windings. In a typical EESM, the rise and fall times of the rotor windings would be on the order of 100 ms, which is many times greater than the desired rise and fall times of 5 ms. FIG. 7 is a graph illustrating an example relationship between voltage rise time and current rise time for rotor filed windings of an EESM. A voltage curve 704 shows that voltage has a fast rise time and then is kept constant. A current curve 708 shows how current first slowly rises with a shallow linear slope and then at about 0.2 seconds accelerates. As shown in FIG. 7, the rise of the current is much slower than the rise of the voltage, where the voltage reaches the maximum voltage in about 0.005 seconds and where the current reaches a maximum value in over 0.025 seconds.

FIG. 8 is a graph of an example rotor flux and inductance versus current for rotor filed windings of a sample EESM. The rotor inductance curve (H) 804 shows that as the current increases inductance decreases. The rotor flux curve (Wb) 808 shows that as current increases flux increases. The rotor flux curve 808 has an approximate linear rise at a first slope from 0 to about 2.5 amps. The magnetic circuit saturates the curve and transitions to a second approximate linear rise from about 7.5 amps to 15 amps. The first slope is greater than the second slope. Between about 2.5 amps and 7.5 amps the rotor flux curve 808 transitions from the first slope to the second slope. The curve formed by the transition region is called a magnetic field knee. A magnetic field knee is the transition between the first linear rise with a slope greater than 1 and the second linear rise with a slope of less than 1. The center of the magnetic field knee 906 may be defined as part of the magnetic field knee, where the slope is equal to one. In the alternative, the magnetic field knee could define this as the rapidly changing slope between the 2 approximately constant slopes. In the specification and claims, the magnetic field knee region is defined as the magnetic field in a range with a minimum equal to the center of the magnetic field knee minus 0.5 Tesla to a maximum equal to the center of the magnetic field knee plus 0.1 Tesla. In some embodiments, a narrower magnetic field knee region is the magnetic field in a range with a minimum equal to the center of the magnetic field knee minus 0.15 Tesla to a maximum equal to the center of the magnetic field knee plus 0.05 Tesla.

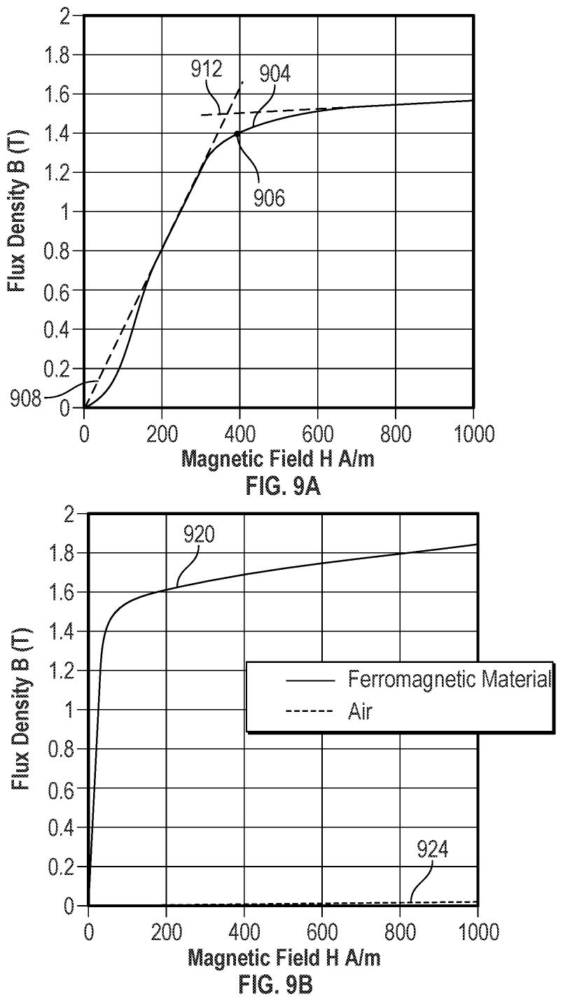

FIG. 9A is a graph of flux density versus magnetic field for an example rotor. A flux field curve 904 has a first linear slope 908 from about 170 H to about 350 H and a second linear slope 912 from about 600 H to about 1000 H. The first linear slope 908 is provided by the relationship B˜μₐμₒH. The second linear slope is caused by magnetic saturation and is provided by the relationship B˜μₒH+Jₛₐₜ. FIG. 9B provides graphs of flux density versus magnetic field for iron and air. Flux field curve 920 is a graph of flux density versus magnetic field for iron. Flux field curve 924 is a graph of flux density versus magnetic field for air.

Referring back to FIG. 5F in order to allow current to transition between 0 amps and 10 amps in the rotor, in the example shown in FIG. 7 it would take more than 25 ms to make such a transition. Some embodiments provide transition times on the order of 5 ms. Some embodiments provide transition times of less than 5 ms.

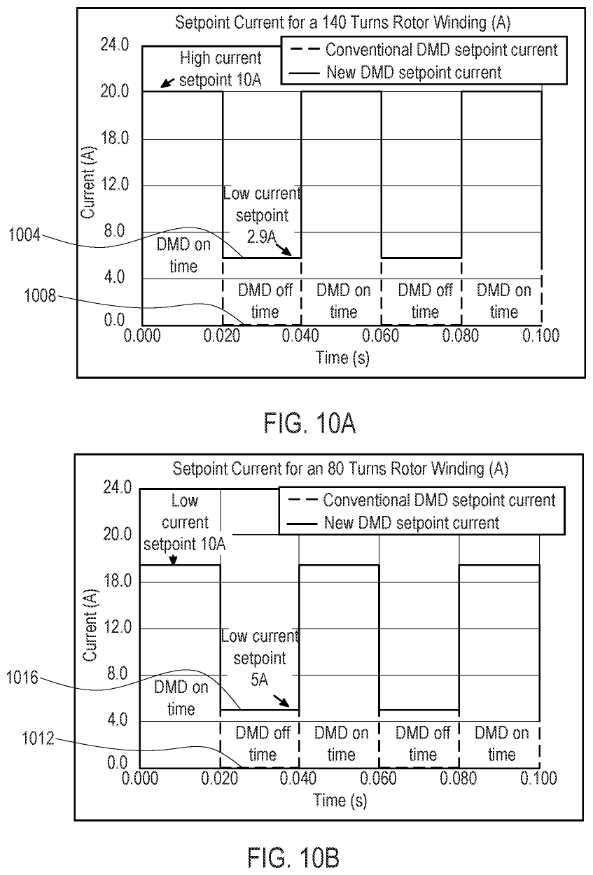

In some embodiments, instead of the low pulsed current, as shown in FIG. 5F, as being 0 amps the minimum pulsed current is a current that provides a rotor flux in the magnetic field knee region of the rotor flux curve 808, shown in FIG. 8. FIG. 10A illustrates a pulsed DC field current 46d curve 1004 that is used in some embodiments with a 140 turn rotor winding compared to the DC field current 46d curve 1008 shown in FIG. 5F. During the dynamic motor drive (DMD) off time, the DC field current 46d curve 1008 provides no current. During the control of the DMD off time, the DC field current 46d curve 1008 provided in some embodiments provides a low current set point of 2.9 amps and an upper current set point of 10 amps. For the rotor with the rotor flux curve 808 shown in FIG. 8, the current of 2.9 amps is in the current magnetic field knee region of the rotor flux curve 808.

Examples of improved rise and fall times are schematically shown in FIG. 6C. As evident in the figure, the ramp-up rise time 66 on the pulse leading edge is faster/shorter as compared to the corresponding ramp-up time 62 shown in FIG. 6B. Similarly, the ramp-down time 68 of the pulse trailing edge is faster/shorter as compared to the corresponding ramp-down time 64 shown in FIG. 6B. Therefore, it should be appreciated that electric machines designed with pulsed control in mind or modified to improve the transient response of the machine to power pulses, can benefit even more from pulsed operation than existing machines.

The minimum and maximum currents for an example 80 turn rotor winding may be calculated from the minimum and maximum currents for the example 140 turn rotor winding according to the equation:

current for 140 windings*(140/80)=current for 140 winding.

2.9 amps*(140/80)=5.0 amps

10 amps*(140/80)=17.5 amps

FIG. 10B illustrates a pulsed DC field current 46d curve 1012 that is used in some embodiments with an 80 turn rotor winding compared to the DC field current 46d curve 1016 shown in FIG. 5F. During the dynamic motor drive (DMD) off time, the DC field current 46d curve 1016 provides no current. During the control of the DMD off time, the DC field current 46d curve 1012 provided in some embodiments provides a low current set point of 5.0 amps and an upper current set point of 17.5 amps.

Some embodiments have a fast rise time and a fast fall time. In some embodiments, the fast rise time is the same length as the fast fall time. In some embodiments, the fast rise time is symmetric with the fast fall time. In some embodiments, the fast rise time and/or fall time of the rotor field windings are the same length and/or symmetric to the fast rise time and/or fall time of the armature windings.

### Operational Flow Diagrams

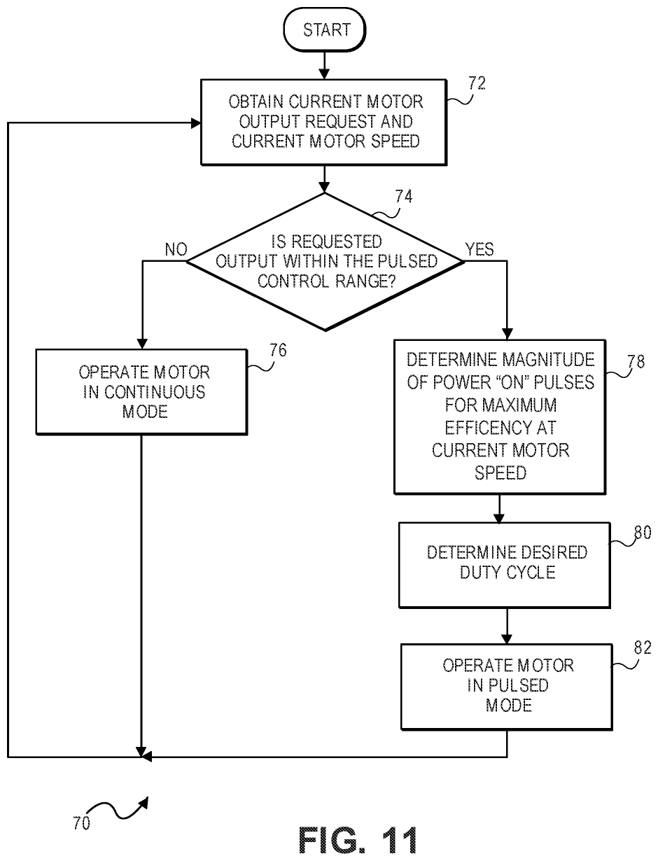

FIG. 11 is a flow diagram 70 illustrating steps for pulsed control operation of an electric machine with characteristics such as those depicted in FIG. 1. In the initial step 72, the current electric machine output and current motor speed are ascertained.

In decision step 74, a determination is made based on the current electric machine output and current electric machine speed if the electric machine should be operated in a continuous mode or a pulsed mode. In other words, a determination is made if the desired electric machine torque is above or below the most efficient output torque for the current electric machine speed (i.e., the maximum efficiency curve 16 of the motor map illustrated in FIG. 1). If above, the motor is operated in the continuous mode. If below, the electric machine may advantageously be operated in the pulsed mode. In step 76, the electric machine is operated in the continuous mode 76 if the current electric machine torque is above the most efficient output torque for the current electric machine speed.

In step 78, the power output or magnitude of the “on” pulses that provide for substantially maximum efficiency operation at the current electric machine speed is determined. In step 80, the desired pulse duty cycle for operation in the pulsed mode is determined so that the average output power or torque matches the desired output.

In step 82, the electric machine is operated in the pulsed mode using the determined pulse duty cycle and pulsed power output. The use of the power controller 30 in various embodiments reduces the rise and fall times of the pulses, further improving motor efficiency.

The above steps 72-82 are continuously performed while the electric machine is in operation. At any particular motor speed, there will be a corresponding most efficient output torque which is diagrammatically illustrated by maximum efficiency curve 16 in FIG. 1. As the instantaneous electric machine output request and/or current electric machine speed change, a decision is made to operate the electric machine in either the continuous or pulsed mode as appropriate. From a conceptual standpoint, when the desired electric machine torque is below the most efficient output torque for the current electric machine speed, the overall efficiency of the electric machine can be improved by pulsing the motor. As a result, for electric motor-powered vehicles, the overall efficiency of the vehicle is improved, meaning the vehicle range between battery recharging is extended.

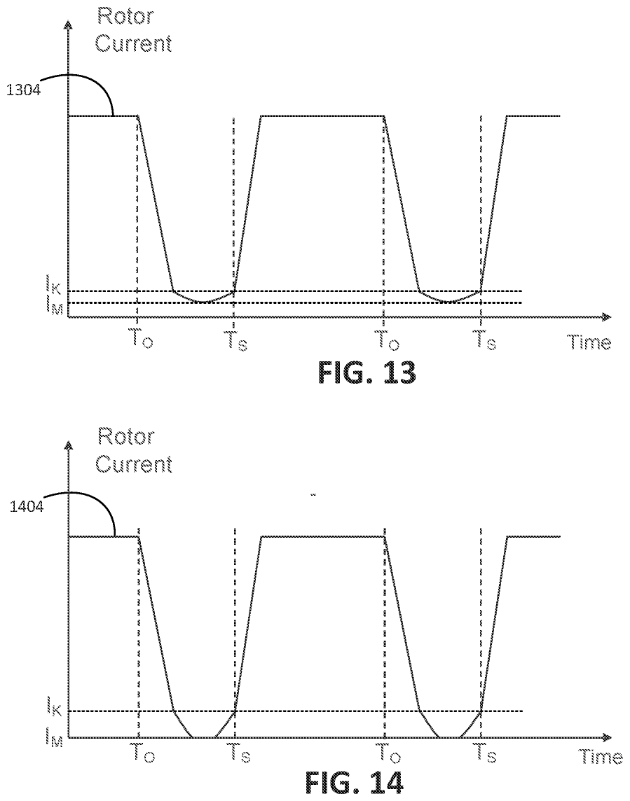

FIG. 13 illustrates a pulsed DC field current 46d curve 1304 that is used in some embodiments. During the dynamic motor drive (DMD) off time (T_{O}), when the current to the stator is switched off, the DC field current 46d curve 1304 initially drops to a knee current (I_{K}) which is a current that provides a magnetic field in the magnetic field knee region. The DC field current 46d more slowly drops below the knee current, as shown in FIG. 13 to a minimum DC field current 46d level (I_{M}). Before the time that the stators are switched on (T_{S}), the DC field current 46d is increased so that at the time that the stators are switched on the DC field current 46d is at the knee current. The further reduction in current allows for the reduction of copper losses. The minimum DC field current may be determined using several parameters, such as rotor voltage, rotor inductance, rotor resistance, and the length of the off time. The length of the off time may depend on the average torque, the maximum torque, pulse frequency, and pulse transition time.

FIG. 14 illustrates a pulsed DC field current 46d curve 1304 that is used in some embodiments. During the dynamic motor drive (DMD) off time (T_{O}), when the current to the stator is switched off, the DC field current 46d curve 1404 initially drops to a knee current (Ix) that is a current that provides a magnetic field in the magnetic field knee region. The DC field current 46d more slowly drops below the knee current, as shown in FIG. 14 to a minimum DC field current 46d level (I_{M}), where the minimum DC field current level is 0 amps. Before the time that the stators are switched on (T_{S}), the DC field current 46d is increased so that at the time that the stators are switched on (T_{S}) the DC field current 46d is at the knee current. Therefore, for a time between a switch on time (T_{O}) and a subsequent switch off time (T_{S}) the DC field current 46d drops to 0 amps.

While this disclosure has been described in terms of several preferred embodiments, there are alterations, modifications, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, modifications, permutations, and various substitute equivalents as fall within the true spirit and scope of the present disclosure.

What is claimed is:

1. An electric machine, comprising:
a power supply;
an electrically excited synchronous machine, comprising:
a stator with stator windings;
a rotor with a plurality of rotor poles, wherein the rotor has a magnetic field knee region; and
rotor field windings around the plurality of rotor poles; and
a power converter coupled between the power supply and the electrically excited synchronous machine, the power converter arranged to provide a pulsed operation by providing a pulsed current to the stator windings and a pulsed DC current to the rotor field windings, wherein the pulsed DC current continuously provides a magnetic field in the rotor.

2. The electric machine, as recited in claim 1, wherein the magnetic field in the rotor is continuously provided at or above the magnetic field knee region of the rotor during the pulsed DC current.

3. The electric machine, as recited in claim 1, wherein the power converter is adapted for delivering a desired output, wherein the pulsed operation creates a current pulse signal in the stator and rotor windings that causes the electrically excited synchronous machine to alternate between at least a first torque level and a second torque level to provide an average torque level, wherein the current pulse signal is selected to provide a higher energy conversion efficiency during the pulsed operation of the electric machine than the electric machine would have when operated at a third torque level that would be required to drive the electric machine in a continuous manner to deliver the same average torque level.

4. The electric machine, as recited in claim 3, wherein the current pulse signal has a frequency of at least 10 Hz, wherein at least one of a rise time and a fall time for the current pulse signal is no more than 5 ms.

5. The electric machine, as recited in claim 4, wherein both the rise time and fall time are no more than 5 ms.

6. The electric machine as recited in claim 1, wherein the electrically excited synchronous machine is an electrically excited synchronous motor.

7. The electric machine, as recited in claim 1, wherein the power converter is further arranged to determine if a desired torque is at a torque where a current pulse signal is not provided as efficiently as a continuous current and providing a continuous current if it is determined that the current pulse signal is not as efficient as the continuous current.

8. The electric machine, as recited in claim 1, wherein the pulsed current to the stator windings provides times when the stators are switched on, wherein at times when the stators are switched on the magnetic field in the rotor is at or above the magnetic field knee region of the rotor during the pulsed DC current.

9. A method of operating an electrically excited synchronous machine comprising a rotor with rotor poles and rotor field windings and a stator with stator windings, comprising:
providing a pulsed operation, comprising:
providing a pulsed current to the stator windings; and
providing a pulsed DC current to the rotor field windings, wherein the pulsed DC current to the rotor field windings creates a magnetic field in the rotor and wherein the rotor has a magnetic field knee region and wherein the magnetic field created by the pulsed DC current is continuously provided in the rotor.

10. The method, as recited in claim 9 wherein the magnetic field in the rotor is continuously provided at or above the magnetic field knee region of the rotor during the pulsed DC current.

11. The method, as recited in claim 9, wherein the providing a pulsed DC current to the rotor windings creates a pulse signal in the rotor field windings that causes the electrically excited synchronous machine to alternate between at least a first torque level and a second torque level which together with the pulsed DC current in the stator winding provides an average torque level, wherein the current pulse signal is selected to provide a higher energy conversion efficiency during the pulsed operation of the electric machine than the electric machine would have when operated at a third torque level that would be required to drive the electric machine in a continuous manner to deliver the same average torque level.

12. The method, as recited in claim 11, wherein the current pulse signal has a frequency of at least 10 Hz, wherein at least one of a rise time and a fall time for the current pulse signal is no more than 5 ms.

13. The method, as recited in claim 12, wherein both the rise time and fall time are no more than 5 ms.

14. The method as recited in claim 12, wherein the electrically excited synchronous machine is an electrically excited synchronous motor or generator.

15. The method, as recited in claim 12, wherein a power converter is connected to the electrically excited synchronous machine, wherein the method further comprises:
determining by the power converter if a desired torque is at a torque where a current pulse signal is not provided as efficiently as a continuous current; and
providing a continuous current if it is determined that the current pulse signal is not as efficient as the continuous current.

16. The method, as recited in claim 9, wherein the pulsed current to the stator windings provides times when the stators are switched on, wherein at times when the stators are switched on the magnetic field in the rotor is at or above the magnetic field knee region of the rotor during the pulsed DC current.

17. An electric machine, comprising:
a power supply;
an electrically excited synchronous machine, comprising:
a stator with stator windings;
a rotor with a plurality of rotor poles, wherein the rotor has a magnetic field knee region; and
rotor field windings around the plurality of rotor poles; and
a power converter coupled between the power supply and the electrically excited synchronous machine, the power converter arranged to provide a pulsed operation by providing a pulsed current to the stator windings, wherein the pulsed operation provides periodic switch off times (T_{O}) and switch on times (T_{S}) for current in the stators and a pulsed DC current to the rotor field windings, wherein at the switch on times (T_{O}) the magnetic field in the rotor is at or above the magnetic field knee region of the rotor.

18. The electric machine, as recited in claim 17, wherein during a time after a switch off time (T_{O}) and before a subsequent switch on time (T_{S}) the magnetic field in the rotor is at or below the magnetic field knee region in the rotor.

19. The electric machine, as recited in claim 17, wherein during a time after a switch off time (T_{O}) and before a subsequent switch on time (T_{S}) the DC current to the rotor field windings is equal to a minimum current, where the minimum current is less than a knee current.

20. The electric machine, as recited in claim 17, wherein the power converter is adapted for delivering a desired output, wherein the pulsed operation creates a current pulse signal in the stator and rotor windings that causes the electrically excited synchronous machine to alternate between at least a first torque level and a second torque level to provide an average torque level, wherein the current pulse signal is selected to provide a higher energy conversion efficiency during the pulsed operation of the electric machine than the electric machine would have when operated at a third torque level that would be required to drive the electric machine in a continuous manner to deliver the same average torque level.

21. The electric machine, as recited in claim 20, wherein the current pulse signal has a frequency of at least 10 Hz, wherein at least one of a rise time and a fall time for the current pulse signal is no more than 5 ms.

22. The electric machine, as recited in claim 21, wherein both the rise time and fall time are no more than 5 ms.

23. The electric machine as recited in claim 17, wherein the electrically excited synchronous machine is an electrically excited synchronous motor.

24. The electric machine, as recited in claim 17, wherein the power converter is further arranged to determine if a desired torque is at a torque where a current pulse signal is not provided as efficiently as a continuous current and providing a continuous current if it is determined that the current pulse signal is not as efficient as the continuous current.

25. The electric machine, as recited in claim 17, wherein during a time after a switch off time (T_{O}) and before a subsequent switch on time (T_{S}) the DC current to the rotor field windings is equal to 0 amps.

26. A method of operating an electrically excited synchronous machine comprising a rotor with rotor poles and rotor field windings and a stator with stator windings, comprising:
providing a pulsed operation, comprising:
providing a pulsed current to the stator windings, wherein the pulsed current to the stator windings provides periodic switch off times (T_{O}) and switch on times (T_{S}) for current in the stators; and
providing a pulsed DC current to the rotor field windings, wherein the pulsed DC current to the rotor field windings creates a magnetic field in the rotor and wherein the rotor has a magnetic field knee region, wherein at the switch on times (T_{O}) the magnetic field in the rotor is at or above the magnetic field knee region of the rotor.

27. The method, as recited in claim 26, wherein during a time after a switch off time (T_{O}) and before a subsequent switch on time (T_{S}) the magnetic field in the rotor is at or below the magnetic field knee region in the rotor.

28. The method, as recited in claim 26, wherein during a time after a switch off time (T_{O}) and before a subsequent switch on time (T_{S}) the DC current to the rotor field windings is equal to a minimum current, where the minimum current is less than a knee current.

29. The method, as recited in claim 26, wherein the providing a pulsed DC current to the rotor windings creates a pulse signal in the rotor field windings that causes the electrically excited synchronous machine to alternate between at least a first torque level and a second torque level which together with the pulsed DC current in the stator winding provides an average torque level, wherein the current pulse signal is selected to provide a higher energy conversion efficiency during the pulsed operation of the electric machine than the electric machine would have when operated at a third torque level that would be required to drive the electric machine in a continuous manner to deliver the same average torque level.

30. The method, as recited in claim 29, wherein the current pulse signal has a frequency of at least 10 Hz, wherein at least one of a rise time and a fall time for the current pulse signal is no more than 5 ms.

31. The method, as recited in claim 30, wherein both the rise time and fall time are no more than 5 ms.

32. The method as recited in claim 26, wherein the electrically excited synchronous machine is an electrically excited synchronous motor or generator.

33. The method, as recited in claim 26, wherein a power converter is connected to the electrically excited synchronous machine, wherein the method further comprises:
determining by the power converter if a desired torque is at a torque where a current pulse signal is not provided as efficiently as a continuous current; and
providing a continuous current if it is determined that the current pulse signal is not as efficient as the continuous current.

34. The method, as recited in claim 26, wherein during a time after a switch off time (T_{O}) and before a subsequent switch on time (T_{S}) the DC current to the rotor field windings is equal to 0 amps.
